(19) United States
(12) Patent Application Publication
(10) Pub. No.: US 2026/0147926 A1
(43) Pub. Date: May 28, 2026

(54) COMPUTER-IMPLEMENTED METHODS, SYSTEMS COMPRISING COMPUTER-READABLE MEDIA, AND ELECTRONIC DEVICES FOR REDACTION OF OPEN BANKING DATA

(71) Applicant: Mastercard International Incorporated, Purchase, NY (US)

(72) Inventors: Chandra Tupelly, Newark, CA (US); Cody Maughan, Bountiful, UT (US); Natesh Babu Arunachalam, Herriman, UT (US); Pavan Teja Nagisetti, South Jordan, UT (US)

(73) Assignee: Mastercard International Incorporated, Purchase, NY (US)

(21) Appl. No.: 18/959,769

(22) Filed: Nov. 26, 2024

(51) Int. Cl. G06F 21/62; G06Q 40/02

(52) U.S. Cl. CPC G06F 21/6254; G06Q 40/02

(57) ABSTRACT

A computer-implemented method for redacting personally identifiable information that includes: identifying information that is not personally identifiable (non-PII) in an open banking transaction record; classifying the open banking transaction record as belonging to one or more personally identifiable information channels (PII channels); based on the PII channel identification, identifying personally identifiable information (PII) in the open banking transaction record, the PII identification including text analysis of the open banking transaction record performed using a first algorithm for the non-PII and a second algorithm for other data of the open banking transaction record; and redacting the identified PII of the open banking transaction record.

### FIELD OF THE INVENTION

The present disclosure generally relates to computer-implemented methods, systems comprising computer-readable media, and electronic devices for redacting open banking data and, more particularly, to filter and identifier pipelines for redacting open banking data.

### BACKGROUND

Open banking services often involve receiving, analyzing, storing and providing voluminous transaction and other records containing personal or sensitive information. However, provision of certain records and information of a first party to a third party may be subject to sharing restrictions. For example, an open banking service or platform may be restricted from sharing personally identifiable information (PII) of a first party with a third party.

The volume of records and information moving through an open banking platform often makes manual review and management of personal or sensitive information sharing between parties impractical. Notwithstanding the need for automated methods for same, the raw and often unstructured data (especially free-text description and memo fields) held in many open banking transaction records frustrates such automated methods. Such raw transaction information is unlike natural language because grammar and syntax clues are significantly reduced or non-existent, and unnecessary or unrelated information (e.g., alphanumeric information) is often included, at times mid-string. Strings that may be related to entity identification may be disrupted, incomplete, unpredictably altered, truncated or the like, e.g., where such a string is encoded by wildcard (*) truncations, is misspelled, is split, is intermingled with seemingly unrelated alphanumeric characters, or is simply partly or entirely omitted.

Components traditionally utilized for identifying sensitive and personal data in such records—e.g., in the combined description and memo fields—have low accuracy. In particular, many such components notoriously provide false positives for sensitive or personal information where, in fact, no such information is present.

What is needed, then, are improved methods for providing open banking services and redaction of PII.

This background discussion is intended to provide information related to the present invention which is not necessarily prior art.

### BRIEF SUMMARY

Embodiments of the present technology relate to computer-implemented methods, systems comprising computer-readable media, and electronic devices for redaction of PII. The embodiments provide a technological mechanism for improved redaction of PII and retention of non-PII, at least in part through providing several component combinations yielding unexpectedly optimized results for improved accuracy and retention of non-PII. The unexpected yield largely derives from the reduction of false positive PII identification realized by the several unique analysis pipelines proposed herein.

More particularly, in an aspect, a computer-implemented method for redacting personally identifiable information may be provided. The method may include: identifying information that is not personally identifiable (non-PII) in an open banking transaction record; classifying the open banking transaction record as belonging to one or more personally identifiable information channels (PII channels); based on the PII channel identification, identifying personally identifiable information (PII) in the open banking transaction record, the PII identification including text analysis of the open banking transaction record performed using a first algorithm for the non-PII and a second algorithm for other data of the open banking transaction record; and redacting the identified PII of the open banking transaction record. The method may include additional, less, or alternate operations, including those discussed elsewhere herein.

In another aspect, non-transitory computer-readable storage media having computer-executable instructions stored thereon for redacting personally identifiable information may be provided. When executed by at least one processor the computer-executable instructions cause the at least one processor to: identify information that is not personally identifiable (non-PII) in an open banking transaction record; classify the open banking transaction record as belonging to one or more personally identifiable information channels (PII channels); based on the PII channel identification, identify personally identifiable information (PII) in the open banking transaction record, the PII identification including text analysis of the open banking transaction record performed using a first algorithm for the non-PII and a second algorithm for other data of the open banking transaction record; and redact the identified PII of the open banking transaction record. The instructions, when executed, may cause the at least one processor to perform additional, less, or alternate operations, including those discussed elsewhere herein.

Advantages of these and other embodiments will become more apparent to those skilled in the art from the following description of the example embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 illustrates various components, in block schematic form, of an example system for redacting personally identifiable information in accordance with embodiments of the present invention;

FIGS. 2, 3 and 4 illustrate various components of example computing devices shown in block schematic form that may be used with the system of FIG. 1;

FIG. 5 illustrates various components of an example storage device and corresponding identifiers and filters that may be used with the system of FIG. 1;

FIG. 6 is a flowchart of example systems and components thereof for redacting personally identifiable information, in accordance with embodiments of the present invention;

FIG. 7 is a flowchart of example systems and components thereof for redacting personally identifiable information, in accordance with embodiments of the present invention;

FIG. 8 is a flowchart of example systems and components thereof for redacting personally identifiable information, in accordance with embodiments of the present invention;

FIG. 9 is a flowchart of example systems and components thereof for redacting personally identifiable information, in accordance with embodiments of the present invention;

FIG. 10 is a flowchart of example systems and components thereof for redacting personally identifiable information, in accordance with embodiments of the present invention; and

FIG. 11 illustrates at least a portion of the operations of an example computer-implemented method for redacting personally identifiable information in accordance with embodiments of the present invention.

The Figures depict example embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Components, such as natural language processing algorithms, traditionally utilized for identifying sensitive and personal data in open banking transaction records—e.g., in combined description and memo fields—have low accuracy. In particular, many such components notoriously provide false positives for sensitive or personal information where, in fact, no such information is present.

What is needed, then, are improved methods for providing open banking services and redaction of personally identifiable information (PII).

Embodiments of the present invention provide a technological mechanism for improved redaction of PII and retention of non-PII, at least in part through providing several component combinations yielding unexpectedly optimized results for improved accuracy and retention of non-PII. The unexpected yield largely derives from the reduction of false positive PII identification realized by the several unique analysis pipelines proposed herein.

### Example System

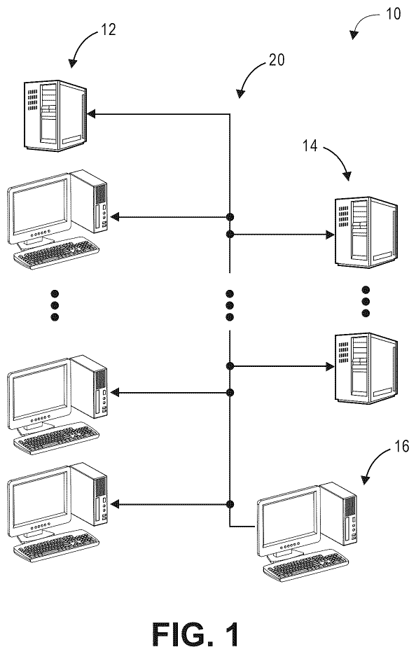

FIG. 1 depicts an example environment 10 for providing open banking services by automatically identifying and redacting PII, according to embodiments of the present invention. The environment may include a plurality of client devices 12, a plurality of servers 14, a service device 16, and a communication network 20. Client devices 12, servers 14 and the service device 16 may be located within network boundaries of an organization, such as a corporation or the like that provides open banking services. One or more client devices 12 and servers 14 may also be outside the network boundaries of the organization.

The communication network 20 may be partly or even mostly internal to the organization, for example where the servers 14 manage databases of and/or provide cloud-based services to and under the management of the organization, and a client device 12 is also under the management of the organization. Also or alternatively, the client devices 12, servers 14 and service device 16 may access each other via transmissions, at least in part, across public/semi-public telecommunication network infrastructure, with the communication network 20 being at least in part comprised of such public/semi-public telecommunication network infrastructure.

All or some of the client devices 12, servers 14, service device 16 and/or all or some of the virtual resources managed thereby, may at least partly comprise a secure network computing environment. Alternatively or in addition, the service device 16 may manage access and transmissions between and among itself and the client devices 12 and servers 14 under an authentication management framework. For example, each user of a client device 12 may be required to complete an authentication process to access secure data provided via the servers 14 and/or the services provided by service device 16. In one or more embodiments, any authentication management framework may be utilized including, without limitation, custom frameworks.

For example, the service device 16 may host, aggregate and analyze data and host and provide access to/use of applications comprising open banking services. In one or more embodiments, the open banking services comprise data aggregation, analysis, management and data sharing services whereby consumers and businesses may subscribe for consented and controlled sharing of data with financial service providers and/or institutions.

Data subjects (e.g., consumers and businesses seeking financial services from financial service providers) may subscribe for the open banking services and identify one or more financial accounts or data/documents sources from which to share data and/or directly provide copies of financial and identification information (e.g., access credentials) and documents. The data subjects may also consent to controlled sharing of such financial, identity-and/or location-related information with the open banking services of the service device 16 and, in turn, with consented data recipients (e.g., the financial service providers).

In turn, data recipients (e.g., lenders, credit score agencies, credit card service providers, or other financial institutions or financial service providers) may subscribe and access the open banking services and subject data, for example to calculate credit scores, open new financial accounts, provide advice about improving credit scores, approve loan requests from data subjects, and perform other financial services.

The consented data provided with the permission of data subjects may be provided directly (e.g., via upload from client devices 12) and/or by directive of the data subjects given to the service device 16 and/or one or more servers 14. For example, a data subject may provide access credentials used to access server(s) 14 which host financial institution or service provider application programming interfaces (APIs), with such APIs providing access to the data subject's financial account records. The data subject may thereby direct the server 14, whether directly or indirectly, to provide the service device 16 with all or some such financial account records, and may establish conditions and parameters around such sharing and/or around subsequent sharing by the service device 16 with data recipients (e.g., financial service providers also subscribed to the open banking services). Consenting to and retrieval of data subject data may take a variety of forms and utilize a variety of data sources having a variety of formats, within the scope of the present invention.

Accordingly, data subjects and data recipients may subscribe for the open banking services, for example through the use of and access provided by service device 16. The open banking services may be provided by the service device 16 to the client devices 12 and/or servers 14. It should again be noted that the service provider or organization providing the open banking services may itself include client devices 12 and service devices 16, for example where the organization asks for PII scrubbed open banking transaction records to use in training machine learning models or other tasks. To provide the open banking services, the organization may observe consent/sharing restrictions described above and/or as prescribed by law at least in part by implementing PII redaction methods and systems described in more detail below.

One of ordinary skill will appreciate that embodiments may serve a wide variety of individuals and organizations and/or rely on a wide variety of data sources (and formats) and/or service providers within the scope of the present invention. It should also be noted that reference herein to a “business organization,” “corporation” or the like are made for ease of reference, and that embodiments of the present invention are equally applicable to individual users and/or partnerships subscribing to and/or providing open banking services.

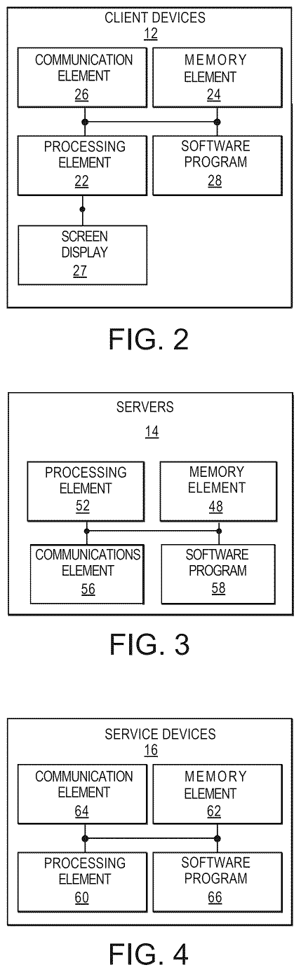

Turning to FIGS. 2 and 4, generally the client devices 12 and the service device(s) 16 may include tablet computers, laptop computers, desktop computers, workstation computers, smart phones, smart watches, and the like. In one or more embodiments, the client devices 12 and/or the service devices 16 may comprise server(s), examples of which are discussed in more detail below.

Client devices 12 and service device(s) 16 may each respectively include a processing element 22, 60, a memory element 24, 62, and circuitry capable of wired and/or wireless communication with the communication network 20, including, for example, a transceiver or communication element 26, 64. Each of the client devices 12 may additionally include a screen display 27, which may comprise a user interface of the client device 12. The display 27 may include video devices of any of the following types: plasma, standard or ultra-high-definition light-emitting diode (LED), organic LED (OLED), quantum dot LED (QLED), Light Emitting Polymer (LEP) or Polymer LED (PLED), liquid crystal display (LCD), thin film transistor (TFT) LCD, LED side-lit or back-lit LCD, or the like, or combinations thereof. The display 27 may possess a square or a rectangular aspect ratio and may be viewed in either a landscape or a portrait mode. In various embodiments, the display 27 may also include a touch screen occupying all or part of the screen.

Further, each of the client devices 12 and the service device 16 may include a software application or program 28, 66 configured with instructions for performing and/or enabling performance of at least some of the operations set forth herein. In an embodiment, the software programs 28, 66 each comprises instructions respectively stored on computer-readable media of a memory element 24, 62.

The servers 14 generally receive requests and/or consents for data sharing from the client devices 12—directly or indirectly via the service device 16—and expose or otherwise provide such subject data and other data to the service device 16 for intake, aggregation, analysis and consented sharing managed by the service device 16. In one or more embodiments, a service device 16 enrolls all or some of the client devices 12 and servers 14 and/or the resources embodied thereby for receipt of and/or participation in the open banking services.

The servers 14 may comprise cloud servers, domain controllers, application servers, database servers, database web servers, file servers, mail servers, catalog servers or the like, or combinations thereof. In one or more embodiments, one or more data sources may be maintained by one or more of the servers 14. For example, the data sources may provide open banking transaction records including open banking data, financial institution (FI) data regarding data subjects, account records, transaction and credit card data, firmographic entity data, location data, regulatory data, PII, entity identification and/or authentication data, and/or other financial and relevant data. In one or more embodiments, unstructured or semi-structured open banking transaction records will include description, memo and payee fields without consistent syntax and/or grammar between them, exacerbating the challenges of identifying PII therein without false positives. Generally, each server 14 may include a memory element 48, a processing element 52, a communication element 56, and a software program 58.

The communication network 20 generally allows communication between the client devices 12, the servers 14, and the service device 16, for example in conjunction with device enrollment, data acquisition, data consenting, data aggregation, data analysis and data sharing with recipient devices in connection with open banking services provided by the service device 16.

The communication network 20 may include the Internet, cellular communication networks, local area networks, metro area networks, wide area networks, cloud networks, plain old telephone service (POTS) networks, and the like, or combinations thereof. The communication network 20 may be wired, wireless, or combinations thereof and may include components such as modems, gateways, switches, routers, hubs, access points, repeaters, towers, and the like. The client devices 12, servers 14 and/or services device(s) 16 may, for example, connect to the communication network 20 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as Wi-Fi, IEEE 802.16 standards such as WiMAX, Bluetooth™, or combinations thereof.

The communication elements 26, 56, 64 generally allow communication between the client devices 12, the servers 14, the service device 16 and/or the communication network 20. The communication elements 26, 56, 64 may include signal or data transmitting and receiving circuits, such as antennas, amplifiers, filters, mixers, oscillators, digital signal processors (DSPs), and the like. The communication elements 26, 56, 64 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard such as Wi-Fi, IEEE 802.16 standard such as WiMAX, Bluetooth™, or combinations thereof. In addition, the communication elements 26, 56, 64 may utilize communication standards such as ANT, ANT+, Bluetooth™ low energy (BLE), the industrial, scientific, and medical (ISM) band at 2.4 gigahertz (GHz), or the like. Alternatively, or in addition, the communication elements 26, 56, 64 may establish communication through connectors or couplers that receive metal conductor wires or cables, like Cat 6 or coax cable, which are compatible with networking technologies such as ethernet. In certain embodiments, the communication elements 26, 56, 64 may also couple with optical fiber cables. The communication elements 26, 56, 64 may respectively be in communication with the processing elements 22, 52, 60 and/or the memory elements 24, 48, 62.

The memory elements 24, 48, 62 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory elements 24, 48, 62 may be embedded in, or packaged in the same package as, the processing elements 22, 52, 60. The memory elements 24, 48, 62 may include, or may constitute, a “computer-readable medium.” The memory elements 24, 48, 62 may store the instructions, code, code segments, software, firmware, programs, applications, apps, services, daemons, or the like that are executed by the processing elements 22, 52, 60. In an embodiment, the memory elements 24, 48, 62 respectively store the software applications/programs 28, 58, 66. The memory elements 24, 48, 62 may also store settings, data, documents, sound files, photographs, movies, images, databases, and the like.

The processing elements 22, 52, 60 may include electronic hardware components such as processors. The processing elements 22, 52, 60 may include digital processing unit(s). The processing elements 22, 52, 60 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing elements 22, 52, 60 may generally execute, process, or run instructions, code, code segments, software, firmware, programs, applications, apps, processes, services, daemons, or the like. For instance, the processing elements 22, 52, 60 may respectively execute the software applications/programs 28, 58, 66. The processing elements 22, 52, 60 may also include hardware components such as finite-state machines, sequential and combinational logic, and other electronic circuits that can perform the functions necessary for the operation of embodiments of the current invention. The processing elements 22, 52, 60 may be in communication with the other electronic components through serial or parallel links that include universal busses, address busses, data busses, control lines, and the like.

Data queries or requests for services may be initiated via user applications embodied, controlled and/or executed by client devices 12, servers 14 and/or service device(s) 16. In an embodiment, access to user applications, client devices 12, servers 14 and/or service device(s) 16 is granted via one or more authentication framework(s), for example where account identification and consents and/or corresponding restrictions are provided by one or both of the open banking service platform and the platform(s) of financial institution(s) at which data subjects hold accounts.

Data sources hosted by the servers 14 may utilize a variety of formats and structures within the scope of the invention. For instance, relational databases and/or object-oriented databases may embody the data sources and may be exposed for queries by one or more corresponding APIs. One of ordinary skill will appreciate that—while examples presented herein may discuss specific types of operating systems and/or databases—a wide variety may be used alone or in combination within the scope of the present invention.

In one or more embodiments, the software program 58 of one or more of the servers 14 may translate data from the authentication management framework and/or from the client device(s) 12 into identity information for use in connection with authenticating individuals or end users (i.e., data subjects or consented data recipients) for access to data and services by the service device 16 and data recipients. One of ordinary skill will appreciate that a variety of user or data subject information—including, without limitation, credentials and/or biometric or device data—may comprise and/or be used to generate the identity information within the scope of the present invention. It is foreseen that the program 58 may function in connection with a variety of authentication frameworks without departing from the spirit of the present invention.

The program 58 may be configured with policies that define limits to data access. The program 58 may permit service device 16 and/or a service provider employee of the open banking service, and/or one or more client device(s) 12 to have limited access to those aspects and data entries/records which are consented by the corresponding data subject (and, optionally, the financial institution(s)) and/or under applicable law, including under the authentication management framework. These limitations may, again, provide the source of restrictions necessitating PII redaction described in more detail below.

One of ordinary skill will appreciate that the software program 28 of one or more of the client devices 12 may similarly manage access by the service device 16 to aspects of the client devices 12 and/or data stored thereby, particularly where such aspects form a part of or relate to the consented data of the data subject. In one or more embodiments, the service device 16 negotiates such limits (e.g., imposed by financial institutions operating the server(s) 14 and/or by client device 12).

In one or more embodiments, the service device 16 implements an open banking service for client devices 12 controlled by data recipient subscribers. The data recipient subscribers, for example, may calculate credit scores, open new financial accounts, provide advice about improving credit scores, approve loan requests and otherwise perform financial-related tasks for data subjects.

Embodiments of the present invention provide filters and identifiers in particularized combinations and/or sequences found to provide unexpectedly high accuracy and low false positive rates for redacting PII.

The filters may be used to identify non-PII with high confidence. The filters may include one or more of a null input filter, a common description and memo filter, a cross customer occurrence lookup filter, one or more regular expression (regex) filter(s), a named entity recognition (NER) filter or model, a non-PII corpus lookup filter, or any combination of the foregoing implemented in any sequence, in each case described in more detail below.

The PII identifiers may be used to identify PII with high confidence, preferably from among data remaining after one or more filters have been applied to remove non-PII from analysis by the PII identifiers. The PII identifiers may include a single pattern regex model, a multiple pattern regex model (e.g., head-tail regex model), a PII channel identification regex model (i.e., PCI identifier), a NER model, a PII corpus lookup model, a word limited text column model, or any combination of the foregoing implemented in any sequence, in each case described in more detail below.

Returning to the filters introduced above, the null input filter may comprise an algorithm configured to identify column headers or other data labels within an open banking transaction record. The null input filter may also be configured to recognize when one or more data field(s) corresponding to such header(s) satisfy null criteria. In a simple embodiment, the null criteria may specify a lack of data elements (e.g., where the field(s) is/are empty), a sequence of alphanumeric characters designated as representing nonce values (e.g., where the field(s) contain repeated instances of “X”), a combination of the foregoing, or other values or combinations of values known to lack informative content or to otherwise not convey or comprise meaningful data.

In one or more embodiments, the null input filter may be configured to evaluate the null criteria across fields spanning multiple column headers (i.e., field type(s)) for a given transaction record, and/or to apply the null criteria discriminately based on the column header(s) for the fields in question. For example, the null criteria may vary depending on the column header (e.g., where the criteria for a “Description” field differs from the criteria for a “Memo” field), and/or may evaluate multiple fields together (e.g., where nonce values and/or empty fields must occur across fields under multiple headers, types or labels to be classified as null input(s)). The null input filter may identify all fields meeting the null criteria as being or comprising non-PII.

It should also be noted that field type(s)—corresponding to column headers or data labels in this discussion for ease of reference—may be determined other than according to formal or structured data headers/labels or similar structured metadata. For example, in one or more embodiments, the field type(s) are used by various algorithms and features of this disclosure to determine criteria and/or algorithms for use in identifying and/or redacting non-PII and/or PII. Such field type(s) may be determined through analysis of the contents of such data field(s), particularly wherever headers or similar labels are unavailable in the data or from the data source in question and/or where the meaning of such label(s) is unknown within the lexicon used by the filters and identifiers discussed herein.

In one or more embodiments, a field's contents will include recognizable data patterns or other features permitting classification of the field as being of a given type within the lexicon implemented with the filters and identifiers discussed herein. For example, where all transaction records of a given file include a field containing one of a limited set of words, and the set comprises words exclusively descriptive of a transaction type, embodiments of the present invention may automatically classify the field type as being descriptive of transaction type, and apply appropriate corresponding criteria and/or algorithms for identifying and/or redacting non-PII and/or PII based thereon. One of ordinary skill will appreciate that such an automated classification for field type(s) may be undertaken in place of or in addition to header/label identification throughout this disclosure without departing from the spirit of the present invention.

Turning next to the common description and memo filter, it may also comprise an algorithm configured to identify column headers or other data labels, or otherwise identify or receive field type(s), within an open banking transaction record. The algorithm may more specifically identify description and memo field types within each record, which are common field types in open banking transaction data. The description field includes data describing or indicative of a combination of a financial transaction type (e.g., transfer, payment or the like) and an account type (e.g., savings, checking or the like). The memo field includes data describing or indicative of a direction of flow of value associated with the financial transaction type (e.g., credit or debit).

Because of the unpredictability and unstructured nature of open banking transaction records, the patterns of data found in the description and memo fields of the records confound available algorithms for automated PII identification. According to embodiments of the present invention, the common description and memo filter combines or concatenates the contents of the description and memo fields for each transaction record, in one or more sequences, and compares the combined description and memo field contents to a corpus of known common non-PII combinations from such fields. Accordingly, if the combined description and memo field contents of a given transaction record match—whether exactly or within a threshold (e.g., according to fuzzy matching)—the strings represented in the corpus of known common non-PII combinations, the combined description and memo fields for the record will be considered as containing non-PII. Also or alternatively, such matching may be considered to signal that the corresponding fields include only non-PII and/or that the transaction record itself includes only non-PII.

It should be noted that the corpus of known common non-PII combinations may be populated regardless of their prevalence across multiple transaction records. For example, a programmer may input a variety of known common non-PII patterns for combined common description and memo fields into the corpus without having first analyzed transaction records to extract those patterns. It may simply be known, for example, that “TransfertoSAV. CREDIT” is a combined common description and memo field string that includes only non-PII, that signals the corresponding fields include only non-PII, and/or that signals the transaction record itself includes only non-PII. Also or alternatively, all or some of the known common non-PII patterns of the corpus may be derived from analysis of transaction records, automatically and/or with the help of human labelers.

Turning next to the cross customer occurrence look up filter, it may also comprise an algorithm configured to identify column headers or other data labels, or otherwise identify or receive field type(s), within an open banking transaction record. The algorithm may more specifically identify description and memo field types within each record, which, again, are common field types in open banking transaction data. Wherever such field type(s) are identified, matching or comparison operations described in more detail below may be selectively done to fields having pre-determined field type(s).

According to embodiments of the present invention, the cross customer occurrence look up filter combines or concatenates the contents of the description and memo fields for each transaction record, in one or more sequences. In one or more embodiments, the cross customer occurrence look up filter also removes certain character types (e.g., numbers) and symbols, along with common words found in a common non-PII word corpus (e.g., “credit,” “debit” or the like), from the combined string including the contents of the description and memo fields. The resultant combined string (i.e., the combined or concatenated contents of description and memo fields with the aforementioned symbols, character types and non-PII words removed) from the transaction record is compared to similarly prepared combination strings extracted from transaction records of a plurality of other customers or transacting entities.

Accordingly, if the resultant combined string prepared according to the operations discussed above matches—exactly or within a threshold (e.g., according to fuzzy matching)—similarly-prepared strings of a threshold number and/or percentage of other customers or transacting entities, the combined description and memo fields for the instant transaction record will be considered as containing non-PII. Also or alternatively, such matching may be considered to signal that the corresponding fields include only non-PII and/or that the transaction record itself includes only non-PII. For example, such classification and/or conclusions may be reached if matching occurs across at least five (5), at least one hundred (100), or at least one thousand (1,000) different customers or transacting entities.

Turning next to the common regex patterns filter, it may also comprise an algorithm configured to identify column headers or other data labels, or otherwise identify field type(s), within an open banking transaction record. The algorithm may more specifically identify description and memo field types within each record. Wherever such field type(s) are identified, matching or comparison operations described in more detail below may be selectively done to fields having pre-determined field type(s).

According to embodiments of the present invention, the common regex patterns filter combines or concatenates the contents of the description and memo fields for each transaction record, in one or more sequences, and compares the combined description and memo field contents to a JavaScript Object Notation (json) file containing common non-PII combinations from such fields. Accordingly, if the combined description and memo field contents of a given transaction record match an entry in the json file—whether exactly or within a threshold (e.g., according to fuzzy matching)—the combined description and memo fields for the record will be considered as containing non-PII. Also or alternatively, such matching may be considered to signal that the corresponding fields include only non-PII and/or that the transaction record itself includes only non-PII.

It should be noted that the known common non-PII combinations may, again, be populated regardless of their prevalence across multiple transaction records. Also or alternatively, all or some of the known common non-PII patterns of the json may be derived from analysis of transaction records, automatically and/or with the help of human labelers.

Broadly, it should be noted that any combination of two (2) or more of the common description and memo filter, the cross customer occurrence lookup filter and the common regex patterns filter may be implemented together by virtue of the common operation comprising separation by duplicate text found in key columns across multiple customers (referred to herein for ease of reference as an “SDK filter”). The supporting corpuses of patterns for each, discussed in more detail above, may be stored and implemented together without departing from the spirit of the present invention.

Turning next to the named entity recognition (NER) filter and model, a business name entity identifier comprising a Spacy based entity recognition model may be utilized to identify business names. The NER filter may also be configured to identify column headers or other data labels, or otherwise identify or receive field type(s), within an open banking transaction record. Wherever such field type(s) are identified, matching, comparison and/or text analysis operations described in more detail below may be selectively done to fields having pre-determined field type(s).

A Spacy based entity recognition NER filter model may comprise an artificial intelligence and/or machine learning model trained and/or that has learned to recognize such business names within transaction record(s). In embodiments in which channel or transaction type identification is undertaken, each such NER model(s) may be trained or otherwise configured or fine-tuned optimally for identification of such information within specific channel or transaction type categories.

In one or more embodiments, the NER filter model(s) comprise a natural language processing (NLP) tool utilizing statistical entity recognition to identify and characterize the entities within the text of the transaction record. The NER model may use word embedding strategies applied at the level of subword features and/or utilizing Bloom embeddings to identify non-overlapping labelled spans of tokens.

The NER model may be built using machine learning programs or techniques. For instance, the service device may utilize information from a high volume of transaction records to develop correlations between aspects of the transaction records—and, particularly, the text contained therein—and the presence of business entity names therein. For example, if a majority or some threshold proportion of transaction records containing a particular string of characters, whether exactly or according to fuzzy matching techniques or the like, also include a business name immediately following the string, the NER model may learn and be configured to recognize the string and identify the subsequent potential name as possible or confirmed non-PII. For another example, if a majority or some threshold proportion of the transaction records of a given channel or transaction type tend to hold one or more business names in a given position within a record or field of the record, the model may learn and be configured to recognize the location or position and identify the corresponding text as possible or confirmed non-PII.

The machine learning program(s) of the NER model(s) may therefore recognize or determine correlations between aspects, characteristics or features (including text) of transaction records on the one hand, and the presence or likely presence of non-PII (i.e., business names) on the other hand. The machine learning techniques or programs may include curve fitting, regression model builders, convolutional or deep learning neural networks, combined deep learning, pattern recognition, or the like. Based upon this data analysis, the machine learning program(s) may learn method(s) for identifying non-PII.

It should be noted that, in supervised machine learning, the program may be provided with example inputs (i.e., prior transaction records) and their associated outputs (i.e., presence or absence of non-PII within the records), and may seek to discover a general rule that maps inputs to outputs for improved non-PII identification. In unsupervised machine learning, the program may be required to find its own structure in unlabeled example inputs. The program may also or alternatively utilize classification algorithms such as Bayesian classifiers and decision trees, sets of pre-determined rules, and/or other algorithms to identify non-PII.

Turning next to the non-PII corpus lookup filter, it may comprise an algorithm configured to identify column headers or other data labels, or otherwise identify or receive field type(s), within an open banking transaction record. Wherever such field type(s) are identified, matching against the corpus of common financial terms or the like described in more detail below may be selectively done to fields having pre-determined field type(s).

According to embodiments of the present invention, the non-PII corpus lookup filter may look for one or more words comprising common financial terms (e.g., “ACH,” “payment,” “withdrawal,” “returned” or the like). In one or more embodiments, the common financial terms corpus used to match against the text of the transaction records may be populated based on the geographic region from which the transaction records originated or in which the transactions of the transaction records took place. In one or more embodiments, the filter may combine or concatenate multiple words or strings in a field to prepare for matching or comparison operations.

In one or more embodiments, the non-PII corpus lookup filter also removes certain character types and symbols from the string of the record against which the corpus is to be matched. The resultant string from the transaction record is compared to similarly prepared strings represented in the corpus.

Accordingly, if the resultant string extracted and/or prepared according to the operations discussed above matches—exactly or within a threshold (e.g., according to fuzzy matching)—similarly prepared strings represented in the corpus, the string and/or the field in which it originated (or the transaction record as a whole) may be designated as comprising or including non-PII.

Embodiments of the present invention may additionally include one or more do not redact features. The do not redact features may comprise one or more filters in the form of corpuses and/or regex-based pattern matchers configured to locate specific tokens or words and to label, flag, delineate, distinguish or otherwise route or manipulate the matching information to ensure non-redaction. The do not redact feature(s) may be applied at one or more points in the flow of operations for identifying non-PII, including those described above, and may improve data quality by ensuring lower false positive redaction events occur on data which should be retained. For example, the do not redact feature(s) may include the non-PII corpus lookup filter and may perform trace matching or comparison against a corpus of common financial keywords populated by a categorization engine. The do not redact feature(s) may also or alternatively include regex-based city and state name string extractor(s) and/or regex-based street name string extractor(s). In one or more embodiments, the do not redact feature(s) may be configured to analyze or may be applied to strings of the transaction records identified as or routed by another component as if containing or comprising PII, thereby removing false positive strings from the body of PII identified by other of the components. The do not redact feature(s) may be selectively applied according to field type(s), as with other filter components above.

Further, the filters may include a logic feature, algorithm and/or model, referred to herein as a “sufficiency filter,” configured to determine that a transaction record or portion thereof has been analyzed by one or more PII identifiers and that the information of the record which has not been determined to include PII may, for purposes of redaction operations, be considered as not containing PII. In one or more embodiments, information of the record which has completed analysis by a pre-determined set of PII identifiers without having been flagged, routed or otherwise treated as PII will be considered for redaction purposes as being, comprising or consisting of non-PII by the sufficiency filter. The criteria of the sufficiency filter—that is, those factors which must be satisfied to determine that a string, field or record has been sufficiently analyzed by PII identifiers to deem any unflagged information as non-PII—may vary depending on the transaction record type, field type, or the like.

For example, analysis by a PII identifier of the contents of a particular field type and/or a particular transaction record and/or transaction type may be sufficient for the sufficiency filter to predict with high accuracy that the transaction record does not contain PII. The sufficiency filter may take into account PII identified by the PII identifier as a factor in the determination. For example, the sufficiency filter may be configured to recognize a field type and/or transaction record or transaction type thereof, and to determine a high likelihood that such a record or field should contain one, but only one, personal name, and no other PII. If one or more PII identifiers has/have already located a personal name in the transaction record, the sufficiency filter may deem the remainder as non-PII.

It should be appreciated that a sufficiency filter may be attached to each PII identifier of a system, to subsets of the PII identifiers, or to all of the PII identifiers collectively, in each case applying logic, algorithms and/or models to the output of the PII identifier(s) to selectively reroute data, fields, and/or transaction records as a whole it considers to be non-PII and remove same from the stream of remaining filters and PII identifiers of any given redaction flow.

Turning next to the PII identifiers, they may include a single pattern regex model, a multiple pattern regex model (e.g., head-tail regex model), a PII channel identification regex model, a NER model, a PII corpus lookup model, a word limited text column model, or the like.

The single pattern regex identifier or model may attempt to locate and/or identify or match sequences of characters stored in a corpus of known PII against the text of the transaction records or a subset of the fields thereof. The sequences essentially comprise search patterns for finding specific sequences of characters within text comprising the transaction records. Regex analysis typically involves searching the text of the record for a string of characters, wherein the characters may vary. A “regular expression” is a pattern that describes a set of strings that match the pattern. In other words, a regex accepts a certain set of strings and rejects the rest. Accordingly, the single pattern regex model searches the text of the transaction records for patterns where common PII is identified.

The single pattern regex model may discriminately apply criteria based on, or search for strings applicable only to, certain field type(s). Accordingly, the single pattern regex model may additionally comprise an algorithm configured to identify column headers or other data labels, or otherwise identify field type(s), within an open banking transaction record. It should also be noted that the single pattern regex model, and/or any other component described herein that relies on identification of field type, may also or alternatively take field type(s) identification from another component—including a component dedicated to generating the field type(s) for all the other component(s)—within the scope of the present invention.

One of ordinary skill will appreciate that the patterns utilized by the single pattern regex model may require the model to preprocess the contents of the corresponding field(s) to be matched against for any given transaction record, for example by removing or replacing certain characters or sequences, concatenating strings, or the like. The preprocessing may be in accordance with the discussion above or otherwise without departing from the spirit of the present invention.

Turning next to the multiple pattern regex identifier or model, it may be configured to locate and/or identify or match head-tail regex patterns between which PII information (e.g., names) may be found. The patterns may, again, be stored in a corpus of known PII patterns. For example, one head pattern could have multiple tail patterns. In one or more embodiments, a merchant's name could have multiple tails or tail types but still satisfy the known patterns. The patterns may be distinguishable but related. The patterns may be represented in a json file, and may comprise a combination of known character sequences and/or functions or rules for matching the remainder of the pattern, such as where a head is defined by one or more character sequences with or without variable characters or fuzzy matching for each position, together with a function or rule for how to match the corresponding tail text to identify PII combinations. For example, a tail pattern could be a date, a state, a symbol or other type or combination of character(s). In one or more embodiments, intervening text between matching head/tail patterns may be presumed as PII. For example, PII information, such as a name, may reside between the head and tail of a matching head-tail pattern.

In one or more embodiments, the service device may be configured to recognize correct positive PII identification within a plurality of transaction records that exhibit a particular head/tail pattern. The service device may be configured to update the json file with each such new head/tail pattern, for example wherever a threshold number of confirmed instances of PII identification for each such pattern are encountered. Accordingly, the multiple pattern regex model may be configured to automatically refresh and update its json file of patterns.

It should again be noted that the regex PII identifiers may utilize exact or fuzzy matching operations within the scope of the present invention.

It should also, and again, be noted that any of the PII identifiers described herein may discriminately apply matching, comparison and/or text analysis operations according to field type(s). Accordingly, the identifier(s) may each or together additionally comprise an algorithm configured to identify column headers or other data labels, or otherwise identify field type(s), within an open banking transaction record. Also or alternatively, the identifier(s) may receive identification of the field type(s) from another component described herein (e.g., a dedicated field type identification component or analogous component(s) of the filter(s)) and/or as a structured data element of, associated with or included with each transaction record itself.

Turning now to the PII channel identification regex identifier or model or PCI identifier, it may comprise an algorithm or model configured to locate and/or identify or match sequences of characters stored in a corpus of known PII channel indicators against the text of the transaction records or a subset of the fields thereof. The sequences essentially comprise search patterns for finding specific sequences of characters within text comprising the transaction records. Regex analysis may proceed as discussed in more detail above with respect to other regex components, though based on the corpus of known PII channel indicators.

Known PII channel indicators may comprise sequences of characters, whether matched using exact or fuzzy matching operations, and whether located in pre-determined field type(s) or anywhere in a transaction record, which conclusively or sufficiently permit the PII channel identification regex model to classify the transaction record as having originated in a particular channel or transaction type. For example, a first set of patterns dedicated to a first field type may be indicative that the transaction record originates with a transaction in a first transaction channel, whereas a second set of patterns dedicated to a second field type may be indicative that the transaction record originates with a transaction in a second transaction channel. It should be appreciated, however, that the text of multiple fields having different types, and/or varying matching thresholds applied to one or more of those field types, within a given transaction record may be taken together when determining a transaction channel for the transaction record.

In one or more embodiments, a first channel may be associated with a transfer transaction type, a second channel may be associated with a non-transfer transaction type, a third channel may be associated with a payment application (app) transaction type, and so on and so forth. The channel identification operation of the PII channel identification regex model may determine whether a transaction record belongs to the first, second, third or other channel type and, accordingly, label, flag, delineate, distinguish or otherwise route or assign the transaction record and/or field(s) thereof for analysis by different components or algorithms described herein. For example, a “transfer” channel identification for the transaction record may cause a first portion of the transaction record (e.g., the text of one or more pre-determined field type(s)) to be analyzed by one or more pre-determined filter(s) and/or PII identifier(s) described herein, and may cause a second portion of the transaction record (e.g., the text of one or more other pre-determined field type(s)) to be analyzed by either another one or more filter(s) and/or PII identifier(s) and/or to be omitted from further analysis (e.g., presumed to comprise or consist of non-PII). One of ordinary skill will appreciate that the channel identification may variously enable higher accuracy PII and non-PII identification within the scope of the present invention.

In an example, one or more algorithms may be configured to receive the output of the PII channel identification regex model, including a determination of transaction type for the record, and to task corresponding portion(s) of the record for analysis by pre-determined filter(s) and/or PII identifier(s) based on that output. In one or more embodiments, a first algorithm calls or comprises one or more filter(s) and/or PII identifiers specifically configured for respectively identifying non-PII and PII in records having the transaction type identified in the output. That is, a first set of pre-determined filter(s) and/or PII identifier(s) may be specifically configured and/or trained for identifying non-PII and PII in transfer type transaction records, whereas a second set of pre-determined filter(s) and/or PII identifier(s) may be specifically configured and/or trained for identifying non-PII and PII in non-transfer type transaction records, and a third set or subset of pre-determined filter(s) and/or PII identifier(s) may be specifically configured and/or trained for identifying non-PII and PII in payment app type transaction records. It will be understood that such specialization may result from differences in formatting—including field type(s) and contents—between transaction records having the differing transaction types or channels.

Accordingly, in one or more embodiments, portions and/or field(s) of the transaction record may be labeled, flagged, delineated, distinguished or otherwise routed as non-PII, optionally based on or using filter(s) specially configured based on transaction or channel type. Similarly, portions and/or field(s) of the transaction record may be labeled, flagged, delineated, distinguished or otherwise routed as PII, optionally based on or using identifiers specially configured based on transaction or channel type. The flow of non-PII portions of the transaction record may be managed by a first algorithm, including where the first algorithm simply flags those non-PII portions as not requiring further analysis. Similarly, the flow of PII portions of the transaction record may be managed by a second algorithm, including where the second algorithm matches the PII portions or potential PII portions to corresponding PII identifiers specially configured based on transaction or channel type.

Turning now to the NER identifier(s) or model(s), a personal entity identifier comprising a Spacy based entity recognition model may be utilized to identify one or more of personal names, business entity names and location entities.

A Spacy based entity recognition NER model may comprise an artificial intelligence and/or machine learning model trained and/or that has learned to recognize such personal names, business names or location information within transaction record(s). As noted above, in embodiments in which channel or transaction type identification is undertaken, each such NER model(s) may be trained or otherwise configured or fine-tuned optimally for identification of such information within specific channel or transaction type categories. Further, multiple such NER model(s) may each be respectively trained, configured and/or tasked specifically for identification of one of personal names, business entity names or location entities.

In one or more embodiments, the NER model(s) comprise a natural language processing (NLP) tool utilizing statistical entity recognition to identify and characterize the entities and locations within the text of the transaction record. The NER model may use word embedding strategies applied at the level of subword features and/or utilizing Bloom embeddings to identify non-overlapping labelled spans of tokens.

The NER model may be built using machine learning programs or techniques. For instance, the service device may utilize information from a high volume of transaction records to develop correlations between aspects of the transaction records—and, particularly, the text contained therein—and the presence of one or more of personal names, business entity names and location entities therein. For example, if a majority or some threshold proportion of transaction records containing a particular string of characters, whether exactly or according to fuzzy matching techniques or the like, also include a personal name or location immediately following the string, the NER model may learn and be configured to recognize the string and identify the subsequent potential name or location portion as possible or confirmed PII or, in the case of business names, possible or confirmed non-PII (as discussed in connection with the NER filter above). For another example, if a majority or some threshold proportion of the transaction records of a given channel or transaction type tend to hold one or more names or locations in a given position within a record or field of the record, the model may learn and be configured to recognize the location or position and identify the corresponding text as possible or confirmed PII (or non-PII, in the case of business names).

The machine learning program(s) of the NER model(s) may therefore recognize or determine correlations between aspects, characteristics or features (including text) of transaction records on the one hand, and the presence or likely presence of PII on the other hand. The machine learning techniques or programs may include curve fitting, regression model builders, convolutional or deep learning neural networks, combined deep learning, pattern recognition, or the like. Based upon this data analysis, the machine learning program(s) may learn method(s) for identifying PII and non-PII.

It should be noted that, in supervised machine learning, the program may be provided with example inputs (i.e., prior transaction records) and their associated outputs (i.e., presence or absence of PII within the records), and may seek to discover a general rule that maps inputs to outputs for improved PII and non-PII identification. In unsupervised machine learning, the program may be required to find its own structure in unlabeled example inputs. The program may also or alternatively utilize classification algorithms such as Bayesian classifiers and decision trees, sets of pre-determined rules, and/or other algorithms to identify PII and non-PII.

In one or more embodiments, the NER identifier model is a “stacked” NER identifier model implemented together with the NER filter discussed in more detail above. For example, where the NER filter identifies a portion of text as comprising a non-PII business name, but the NER identifier model identifies a corresponding or overlapping portion of text (or the same portion or string) as PII, the system may give more weight to the conclusion of the NER filter and designate the impacted portion(s) or string(s) as being non-PII to avoid false positive identification of business names.

Turning next to the PII corpus lookup identifier or model, it may comprise an algorithm configured to identify column headers or other data labels, or otherwise identify field type(s), within an open banking transaction record. Wherever such field type(s) are identified, matching against the corpus of common names described in more detail below may be selectively done to fields having pre-determined field type(s).

According to embodiments of the present invention, the PII corpus lookup model may look for one or more words comprising common names (e.g., “John,” “Walter,” “Jose,” “Elizabeth” or the like). In one or more embodiments, the common names corpus used to match against the text of the transaction records may be populated based on the geographic region from which the transaction records originated or in which the transactions of the transaction records took place. In one or more embodiments—particularly, wherever a PII corpus lookup model is over-identifying PII—the model may be configured to look for combinations of two or more words comprising matching names to reach a positive PII identification. In such cases, the model may combine or concatenate multiple words or strings in a field to prepare for matching or comparison operations.

In one or more embodiments, the PII corpus lookup identifier or model also removes certain character types and symbols from the string of the record against which the corpus is to be matched. The resultant string from the transaction record is compared to similarly prepared strings represented in the corpus.

Accordingly, if the resultant string extracted and/or prepared according to the operations discussed above matches—exactly or within a threshold (e.g., according to fuzzy matching)—similarly prepared strings represented in the corpus, the string and/or the field in which it originated (or the transaction record as a whole) may be designated as comprising or including PII.

It should be noted again that do not redact features discussed in more detail above are optionally applied to text identified as PII initially by one or more PII identifiers discussed above to, for example, ensure that non-PII (such as common trademarks or tradenames of businesses, including those comprising common surnames) is not improperly or unintentionally identified as PII by those identifier(s) (i.e., to reduce false positives).

Turning finally to the word limited text column identifier or model, it may comprise an algorithm configured to identify column headers or other data labels, or otherwise identify field type(s), within an open banking transaction record. Wherever such field type(s) are identified, application of the word limitation criteria described in more detail below may be selectively done to fields having pre-determined field type(s).

More particularly, the word limited text column model may be configured to extract all content comprising one or two words (only) in a single field. As noted above, in one or more embodiments the field must also be of a pre-determined field type. In one or more embodiments, however, the field may be any of the fields of a transaction record. Such field contents may be presumed to comprise PII (e.g., presumed to be names), or the word limited text column model may additionally compare the field contents satisfying the word number limitation to a common names corpus to reduce false positive PII identification. Fields or the contents thereof satisfying one or both of these criteria may be labeled, flagged, delineated, distinguished or otherwise routed or manipulated in a manner appropriate for PII.

It should be noted that the patterns—whether learned by and embodied in a filter, identifier and/or model, populating a corpus and/or regex algorithm for comparison or matching, or otherwise described in connection with any of the filters and identifiers discussed herein—supporting non-PII or PII identification hereunder may be determined and/or populated based on prevalence across multiple transaction records and multiple different accountholders or customers, as discussed in more detail above. Also or alternatively, all or some of the patterns may be derived from analysis of transaction records, automatically and/or with the help of human labelers, again as discussed in more detail above. In one or more embodiments, all or some of the patterns may be manually input or imported from existing pattern databases.

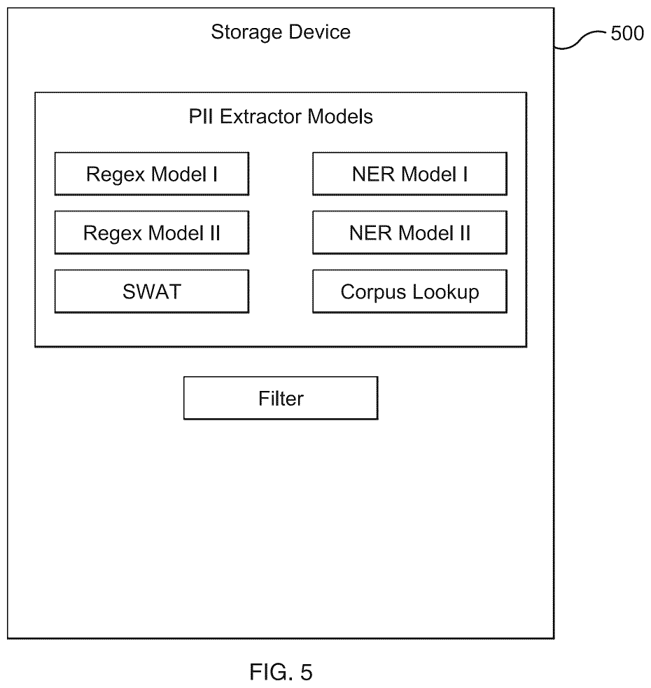

Turning now to FIG. 5, an example storage device 500 may correspond to a service device 16 of FIG. 1. The storage device 500 may host, execute, and/or manage execution of the filters and PII identifiers discussed herein and corresponding redaction of transaction records.

The illustrated example device 500 includes PII extractor models including filter(s) and identifier(s), comprising a regex model I (corresponding to the single pattern regex identifier discussed above), a regex model II (corresponding to the multiple pattern regex identifier discussed above), a SWAT model (corresponding to the word limited text column identifier discussed above), an NER model I (corresponding to the NER filter discussed above), an NER model II (corresponding to the NER identifier discussed above, also referred to as a “stacked” NER when utilized with the NER filter), a corpus lookup model (corresponding to the PII corpus lookup identifier discussed above), and one or more other filter(s) (corresponding to any one or more of the null input filter, common description and memo filter, cross customer occurrence lookup filter, one or more regular expression (regex) filter(s), and/or non-PII corpus lookup filter discussed above). One of ordinary skill will appreciate from the discussions that follow, however, that more or fewer filters and/or PII identifiers may be included and/or utilized within the scope of the present invention.

Various combinations and sub combinations of these components provide technological mechanisms for improved redaction of PII and retention of non-PII, at least in part through providing several component combinations yielding unexpectedly optimized results for improved accuracy and retention of non-PII. The unexpected yield largely derives from the reduction of false positive PII identification realized by the several unique analysis pipelines proposed herein.

Through hardware, software, firmware, or various combinations thereof, the processing elements 22, 52, 60 may—alone or in combination with other processing elements—be configured to perform the operations of embodiments of the present invention. Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The system may include additional, less, or alternate functionality and/or device(s), including those discussed elsewhere herein. The following detailed description is, therefore, not to be taken in a limiting sense. The scope of the present invention is defined only by the appended claims, along with the full scope of equivalents to which such claims are entitled, unless otherwise expressly stated and/or readily apparent to those skilled in the art from the description.

### Example Redaction Pipelines

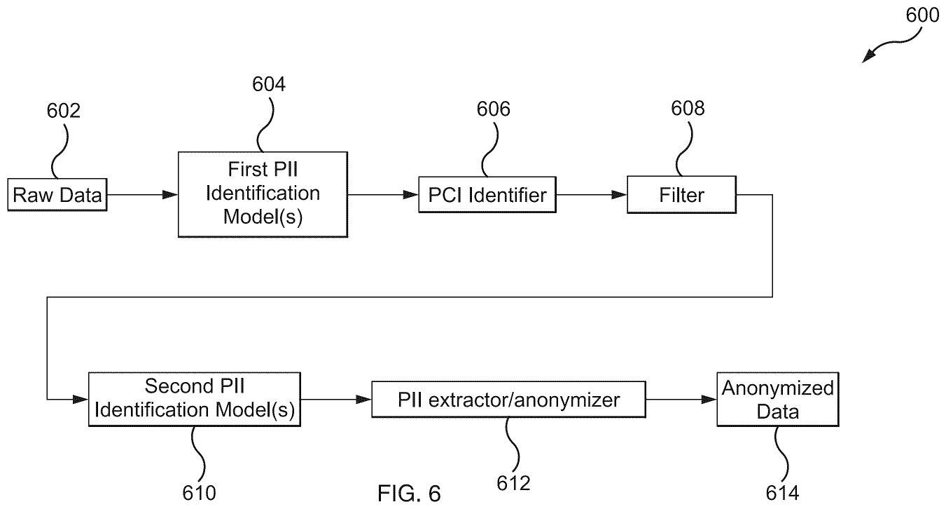

It should be reiterated that the settings and configurations used for PII redaction under embodiments of the present invention may be based on, for example: data subject consent(s) and limitation(s) thereof associated with various usage scenarios (e.g., less data may be redacted for a first third party and/or use case, such as where records are provided to a third party for loan approval, whereas more data may be redacted for a second third party and/or use case such as where records are provided to another third party for provision of a different service); the identity or requirements of a third party recipient or the like; data provider or financial institution requirements or restrictions; regulatory and/or governmental requirements or restrictions; open banking platform policies; and/or on other bases. It should also be noted that FIGS. 6-10 focus on candidate PII data streams between components, and therefore will in certain examples omit illustration of non-PII data streams and/or PII data streams which are not submitted to downstream filter(s) and/or PII identifier(s), for the sake of clarity, though such omitted streams may be described herein.

FIG. 6 depicts an example flow 600 comprising a sub combination of the components proposed above, configured for computationally efficient redaction with reduced false positive rates. More particularly, the flow 600 proceeds, preferably sequentially, as described here.

Initially raw data 602 such as open banking transaction records are submitted to one or more first PII identifiers 604. The one or more first PII identifiers 604 may be one or more of the PII identifiers described in more detail in the preceding sections of this disclosure. The first PII identifiers 604 may individually or in group(s) generate first stream(s) of non-PII data (e.g., via sufficiency filter, as discussed elsewhere herein), stream(s) of PII data, and/or stream(s) of candidate PII data.

In one or more embodiments: a non-PII data stream is labeled, flagged, delineated, distinguished or otherwise routed for inclusion in a redacted transaction record and excluded from further analysis for PII identification; a PII data stream is labeled, flagged, delineated, distinguished or otherwise routed for redaction and excluded from further analysis for PII identification; and a candidate PII data stream is labeled, flagged, delineated, distinguished or otherwise routed for further analysis by PII identifier(s) and/or filter(s). It should be noted that a PII identifier may identify data in the candidate PII data stream as PII in the first instance that is nonetheless routed into the candidate PII data stream for further analysis (e.g., for confirmation of PII or non-PII status).

The candidate PII data stream(s) output by the first PII identifier(s) 604 may be submitted to a PCI channel identifier 606. The PCI channel identifier 606 may correspond to the PII channel identification regex model discussed above. The PCI channel identifier 606 may output one or more second candidate PII data streams based on the transaction channel identification processes of the identifier. For example, second output streams of the PCI channel identifier 606 may include a stream of data and/or transaction records determined to have originated with transfer transaction channel(s) and a stream of data and/or transaction records determined to have originated with non-transfer transaction channel(s).

Further, one or more of the output stream(s) of the PCI channel identifier 606 may be submitted to one or more filter(s) 608. The one or more filter(s) 608 may be one or more of the filters described in more detail in the preceding sections of this disclosure. The filter(s) 608 may individually or in group(s) generate third stream(s) of non-PII data and/or of candidate PII data. As discussed in more detail above, the filter(s) 608 may respectively be configured specifically for identification of non-PII within transaction records having the identified transaction channel(s) (e.g., transfer, non-transfer, payment app, etc.). In one or more embodiments, the candidate PII data output stream of a filter described in this disclosure may merely comprise data remaining after the non-PII data output stream is identified without departing from the spirit of the present invention.

The candidate PII data stream(s) output by the filter(s) 608 may, in turn, be submitted to one or more second PII identifiers 610. The one or more second PII identifiers 610 may be one or more of the PII identifiers described in more detail in the preceding sections of this disclosure. The second PII identifiers 610 may individually or in group(s) generate fourth output stream(s) of non-PII data (e.g., via sufficiency filter, as discussed elsewhere herein), of PII data, and/or of candidate PII data. As discussed in more detail above, the second PII identifier(s) 610 may respectively be configured specifically for identification of PII within transaction records having the identified transaction channel(s) (e.g., transfer, non-transfer, payment app, etc.).

Generally, in each flow described herein and illustrated in the drawings, PII identifiers may produce non-PII streams at any stage through application of sufficiency filters described above. The sufficiency filters may be applied to the output of each PII identifier individually or to any combination of PII identifier(s) and/or filter(s) within the scope of the present invention.

The sufficiency filter(s) of or analyzing output of the one or more second PII identifier(s) may be configured to treat all data not identified as PII as non-PII, and to include the non-PII as a non-PII output stream, again as discussed in more detail above.

All PII identified at any point in the flow of FIG. 6 (i.e., included within any PII output data stream) may be submitted to and/or redacted by the PII extractor/anonymizer 612. For example, in one or more embodiments, redaction includes deleting the PII, replacing the PII characters and/or strings with nonce symbols or other meaningless or encrypted characters, or the like.

The non-PII (i.e., data included in any output non-PII data stream(s)) may be submitted to the anonymized data operation 614, which may output one or more redacted or anonymized transaction records. In one or more embodiments, the transaction record(s) may be reassembled by placing non-PII and redacted text (i.e., deleted spaces or non-characters) back in original positions within each transaction record. In one or more embodiments, reconstruction is unnecessary except to the extent of redacting the characters comprising PII. The resulting redacted or anonymized transaction records may be outputted or transmitted to a third party requester via an open banking platform.

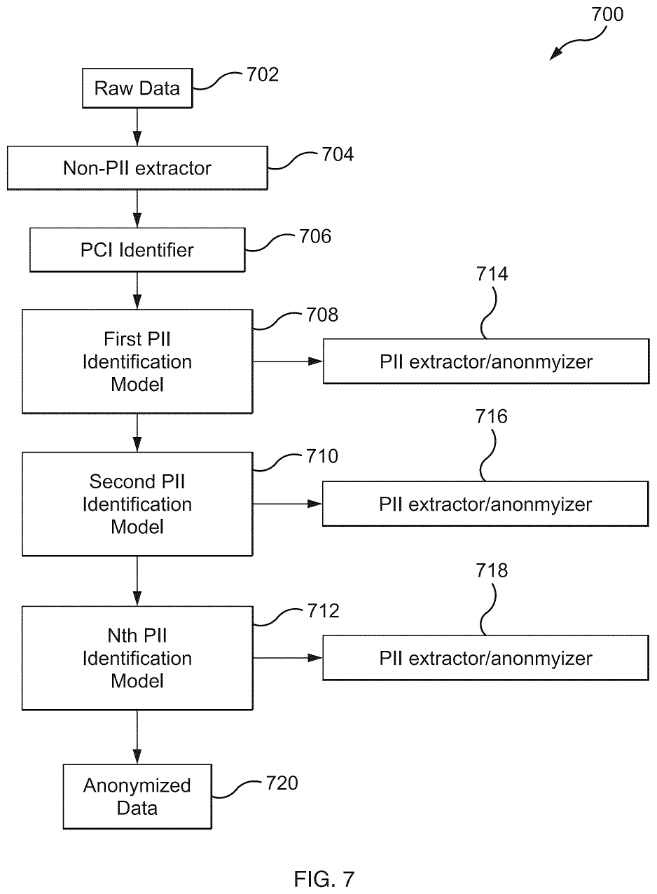

FIG. 7 depicts an example flow 700 comprising a sub combination of the components proposed above, configured for computationally efficient redaction with reduced false positive rates based on transaction channel(s). More particularly, the flow 700 proceeds, preferably sequentially, as described here.

Initially raw data 702 such as open banking transaction records are submitted to one or more non-PII extractors 704 (i.e., filter(s)). The non-PII extractors 704 may be one or more of the filters described in more detail in the preceding sections of this disclosure. The filter(s) may individually or in group(s) generate first stream(s) of non-PII data and/or of candidate PII data.

The first candidate PII data output stream(s) from the one or more filter(s) may be input to a PCI identifier 706. The PCI channel identifier 706 may correspond to the PII channel identification regex model discussed above. The PCI channel identifier 706 may output one or more second candidate PII data streams based on the transaction channel identification processes of the identifier. For example, second output streams of the PCI channel identifier 706 may include a stream of data and/or transaction records determined to have originated with transfer transaction channel(s) and a stream of data and/or transaction records determined to have originated with non-transfer transaction channel(s).

One or more of the output stream(s) of the PCI identifier 706 is submitted to a first of N PII identifiers, which include first and second PII identification models 708, 710 and an Nth PII identification model 712. The N PII identifiers may be selected from among the PII identifiers described in more detail in the preceding sections of this disclosure. Each of the N PII identifiers may generate a stream of non-PII data (e.g., via sufficiency filter, as discussed elsewhere herein), a stream of PII data, and/or a stream of candidate PII data. In turn, the candidate PII data stream output by one of the N PII identifiers is input to the next of the N PII identifiers, and so on and so forth.

As discussed in more detail above, the N PII identifier(s) may respectively be configured specifically for identification of PII within transaction records having the identified transaction channel(s) for the corresponding input PII candidate data stream(s) (e.g., transfer, non-transfer, payment app, etc.). The sufficiency filter(s) of or which analyze output of the Nth PII identifier 712 may be configured to treat all data not identified as PII as non-PII, and to include the non-PII as a non-PII output stream, again as discussed in more detail above.

All PII identified at any point in the flow 700 of FIG. 7 (i.e., included within any PII output data stream) may be submitted to and/or redacted by one or more PII extractor/anonymizer(s) 714, 716, 718. For example, in one or more embodiments, redaction includes deleting the PII, replacing the PII characters and/or strings with nonce symbols or other meaningless or encrypted characters, or the like.

The non-PII (i.e., data included in any output non-PII data stream(s)) may be submitted to the anonymized data operation 720, which may output one or more redacted or anonymized transaction records. In one or more embodiments, the transaction record(s) may be reassembled by placing non-PII and redacted text (i.e., deleted spaces or non-characters) back in original positions within each transaction record. In one or more embodiments, reconstruction is unnecessary except to the extent of redacting the characters comprising PII. The resulting redacted or anonymized transaction records may be outputted or transmitted to a third party requester via an open banking platform.

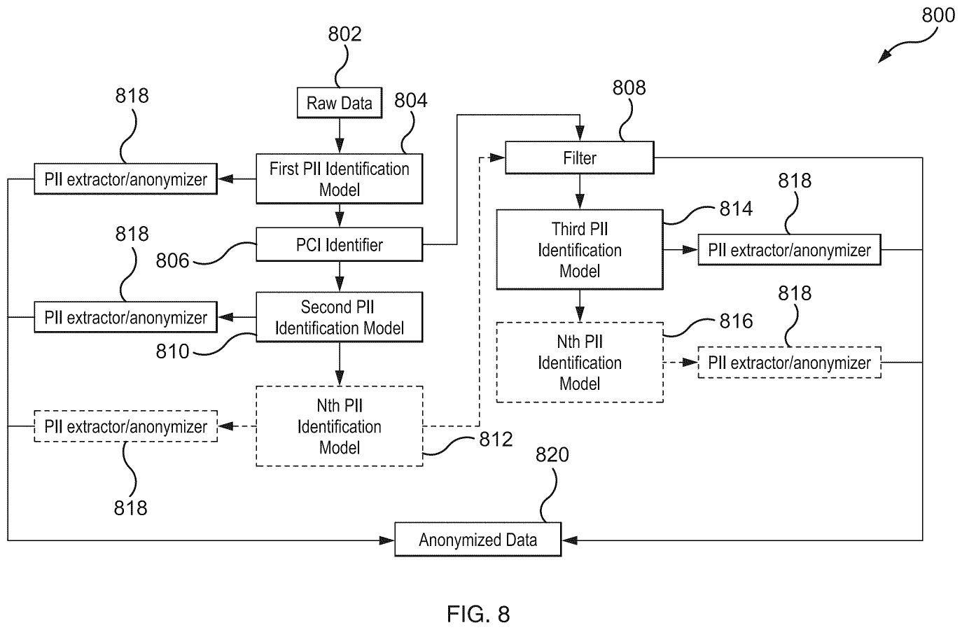

FIG. 8 depicts an example flow 800 comprising a sub combination of the components proposed above, configured for computationally efficient redaction with reduced false positive rates based on transaction channel(s). More particularly, the flow 800 proceeds, preferably sequentially, as described here.

Initially raw data 802 such as open banking transaction records are submitted to one or more first PII models or identifiers 804. The one or more first PII identifiers 804 may be one or more of the PII identifiers described in more detail in the preceding sections of this disclosure. The first PII identifier(s) 804 may individually or in group(s) generate first stream(s) of non-PII data (e.g., via sufficiency filter, as discussed elsewhere herein), stream(s) of PII data, and/or stream(s) of candidate PII data.

The first candidate PII data output stream(s) from the one or more first PII identifiers 804 may be input to a PCI identifier 806. The PCI channel identifier 806 may correspond to the PII channel identification regex model discussed above. The PCI channel identifier 806 may output one or more second candidate PII data streams based on the transaction channel identification processes of the identifier. For example, second output streams of the PCI channel identifier 806 may include a stream of data and/or transaction records determined to have originated with transfer transaction channel(s) and a stream of data and/or transaction records determined to have originated with non-transfer transaction channel(s).

One or more of the output stream(s) of the PCI channel identifier 806, such as the second candidate PII data stream(s) originating with non-transfer transaction channel(s), is submitted to one or more filter(s) 808, discussed in more detail below. One or more other of the output stream(s) of the PCI channel identifier 806, such as the second candidate PII data stream(s) identified as originating with transfer transaction channel(s), is submitted to one or more second PII identifiers 810.

The one or more second PII identifiers 810 and each of the corresponding N PII identifiers may be one or more of the PII identifiers described in more detail in the preceding sections of this disclosure. The second PII identifier(s) 810 may individually or in group(s) generate third stream(s) of non-PII data (e.g., via sufficiency filter, as discussed elsewhere herein), of PII data, and/or of candidate PII data. Each of the one or more second PII identifiers 810 (and subsequent N PII identifiers) may respectively be configured specifically for identification of PII within transaction records having the identified transaction channel(s) for the corresponding input PII candidate data stream(s) (e.g., transfer transactions).

Each of the N PII identifiers downstream of the second PII identification model may receive as input the PII candidate data stream(s) from the preceding one of the N PII identifiers and generate its own output streams of non-PII data (e.g., via sufficiency filter, as discussed elsewhere herein), of PII data, and/or of candidate PII data. The sufficiency filter(s) of or which analyze output of the Nth PII identifier 812 may be configured to treat all data not identified as PII as candidate PII, and to include the candidate PII as a candidate PII output stream for input to the one or more filter(s).

The candidate PII output stream(s) of the one or more second through Nth PII identifiers 810-812, and, as noted above, one or more candidate PII output stream(s) of the PCI Identifier 806 (e.g., the stream associated with non-transfer transaction records), are input to the one or more filter(s) 808. The filter(s) 808 may be one or more of the filters described in more detail in the preceding sections of this disclosure. The filter(s) 808 may individually or in group(s) generate fourth stream(s) of non-PII data and/or of candidate PII data. As discussed in more detail above, the filter(s) 808 may respectively be configured specifically for identification of non-PII within transaction records having the identified transaction channel(s) for the corresponding input PII candidate data stream(s) (e.g., transfer or non-transfer).

The fourth candidate PII data output stream(s) from the one or more filter(s) may be input to one or more third PII identifiers 814. The one or more third PII identifiers 814 and each of the corresponding M PII identifiers may be one or more of the PII identifiers described in more detail in the preceding sections of this disclosure. The third PII identifier(s) 814 may individually or in group(s) generate fifth stream(s) of non-PII data (e.g., via sufficiency filter, as discussed elsewhere herein), stream(s) of PII data, and/or stream(s) of candidate PII data. Each of the one or more third PII identifiers 814 (and subsequent M PII identifiers) may respectively be configured specifically for identification of PII within transaction records having the identified transaction channel(s) for the corresponding input PII candidate data stream(s) (e.g., transfer or non-transfer transactions).

Each of the M PII identifiers downstream of the third PII identification model 814 may receive as input the PII candidate data stream(s) from the preceding one of the M PII identifiers and generate its own output streams of non-PII data (e.g., via sufficiency filter, as discussed elsewhere herein), of PII data, and/or of candidate PII data. The sufficiency filter(s) of or which analyze output of the Mth PII identifier 816 may be configured to treat all data not identified as PII as non-PII, and to include the non-PII in a non-PII output stream.

All PII identified at any point in the flow 800 of FIG. 8 (i.e., included within any PII output data stream) may be submitted to and/or redacted by one or more PII extractor/anonymizer(s) 818. For example, in one or more embodiments, redaction includes deleting the PII, replacing the PII characters and/or strings with nonce symbols or other meaningless or encrypted characters, or the like.

The non-PII (i.e., data included in any output non-PII data stream(s)) may be submitted to the anonymized data operation 820, which may output one or more redacted or anonymized transaction records. In one or more embodiments, the transaction record(s) may be reassembled by placing non-PII and redacted text (i.e., deleted spaces or non-characters) back in original positions within each transaction record. In one or more embodiments, reconstruction is unnecessary except to the extent of redacting the characters comprising PII. The resulting redacted or anonymized transaction records may be outputted or transmitted to a third party requester via an open banking platform.

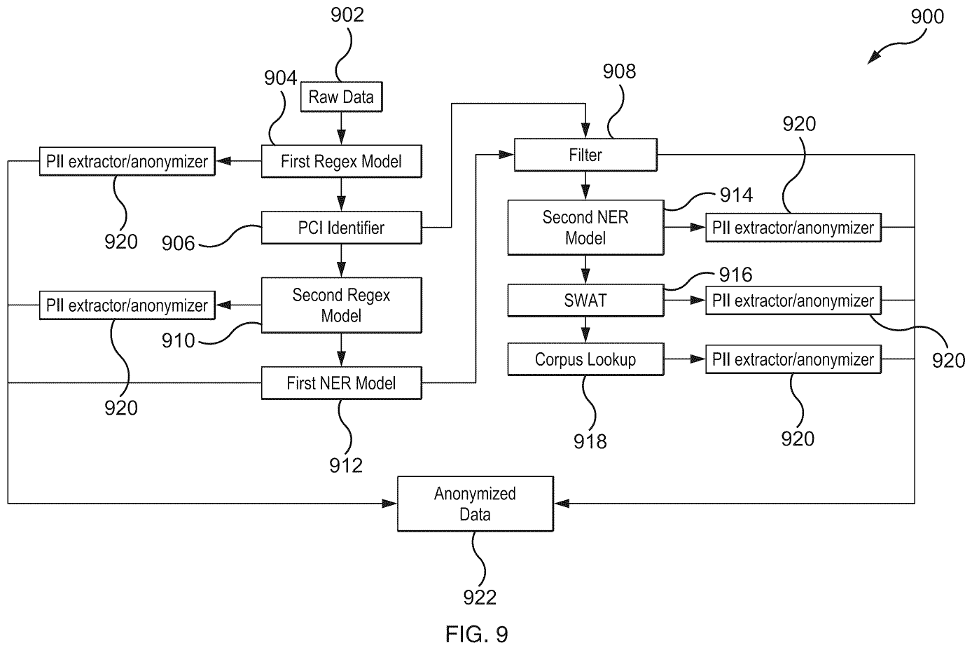

FIG. 9 depicts an example flow 900 comprising a sub combination of the components proposed above, configured for computationally efficient redaction with reduced false positive rates based on transaction channel(s). More particularly, the flow 900 proceeds, preferably sequentially, as described here.

Initially raw data 902 such as open banking transaction records are submitted to a first PII identifier 904 comprising a regex model. The first regex model 904 may be as described in more detail in preceding sections in connection with Regex Model I. The first regex model 904 may generate first stream(s) of non-PII data (e.g., via sufficiency filter, as discussed elsewhere herein), stream(s) of PII data, and/or stream(s) of candidate PII data.

The first candidate PII data output stream(s) from the first regex model 904 may be input to a PCI identifier 906. The PCI channel identifier 906 may correspond to the PII channel identification regex model discussed above. The PCI channel identifier 906 may output one or more second candidate PII data streams based on the transaction channel identification processes of the identifier. For example, second output streams of the PCI channel identifier 906 may include a stream of data and/or transaction records determined to have originated with transfer transaction channel(s) and a stream of data and/or transaction records determined to have originated with non-transfer transaction channel(s).

One or more of the output stream(s) of the PCI channel identifier 906, such as the second candidate PII data stream(s) originating with non-transfer transaction channel(s), is submitted to one or more filter(s) 908, discussed in more detail below. One or more other of the output stream(s) of the PCI channel identifier 906, such as the second candidate PII data stream(s) identified as originating with transfer transaction channel(s), is submitted to a second PII identifier 910 comprising a regex model. The second regex model 910 may be as described in more detail in preceding sections in connection with Regex Model II. The second regex model 910 may generate third stream(s) of non-PII data (e.g., via sufficiency filter, as discussed elsewhere herein), stream(s) of PII data, and/or stream(s) of candidate PII data. As discussed in more detail above, the second regex model 910 may be configured specifically for identification of PII within transaction records having the identified transaction channel(s) for the corresponding input PII candidate data stream(s) (e.g., transfer).

The third stream of candidate PII data output by the second regex model 910 may be submitted to a first NER model 912. The first NER model 912 may be as described in more detail in preceding sections in connection with the NER filter model configured for identifying non-PII comprising business names, trademarks or the like. The first NER model 912 may generate fourth stream(s) of non-PII data and/or of candidate PII data. As discussed in more detail above, the first NER model 912 may be configured specifically for identification of non-PII within transaction records having the identified transaction channel(s) for the corresponding input PII candidate data stream(s) (e.g., transfer).

The candidate PII output stream(s) of the first NER model 912, and, as noted above, one or more candidate PII output stream(s) of the PCI Identifier 906 (e.g., the stream associated with non-transfer transaction records) are input to the one or more filter(s) 908. The filter(s) 908 may be one or more of the filters described in more detail in the preceding sections of this disclosure. The filter(s) 908 may individually or in group(s) generate fifth stream(s) of non-PII data and/or of candidate PII data. As discussed in more detail above, the filter(s) 908 may respectively be configured specifically for identification of non-PII within transaction records having the identified transaction channel(s) for the corresponding input PII candidate data stream(s) (e.g., respectively, transfer or non-transfer).

The fifth candidate PII data output stream(s) from the one or more filter(s) 908 may be input to a second NER model 914. The second NER identifier model 914 may be as described in more detail in preceding sections in connection with the stacked NER model configured for identifying PII comprising personal names, locations or the like. The second NER identifier model 914 may generate sixth stream(s) of non-PII data (e.g., via sufficiency filter, as discussed elsewhere herein), stream(s) of PII data, and/or stream(s) of candidate PII data. As discussed in more detail above, the second NER identifier model 914 may be configured specifically for identification of PII within transaction records having the identified transaction channel(s) for the corresponding input PII candidate data stream(s) (e.g., respectively, transfer or non-transfer). Also as discussed in more detail above, any PII identified by the second NER model 914 which was also identified as non-PII by the first NER model may be treated as non-PII.

The sixth candidate PII data output stream(s) from the second NER identifier model 914 may be input to a SWAT identifier 916 (e.g., model). The SWAT model identifier 916 may be as described in more detail in preceding sections. The SWAT identifier 916 may generate seventh stream(s) of non-PII data (e.g., via sufficiency filter, as discussed elsewhere herein), stream(s) of PII data, and/or stream(s) of candidate PII data. As discussed in more detail above, the SWAT identifier 916 may be configured specifically for identification of PII within transaction records having the identified transaction channel(s) for the corresponding input PII candidate data stream(s) (e.g., respectively, transfer or non-transfer).

The seventh candidate PII data output stream(s) from the SWAT identifier 916 may be input to a corpus lookup identifier 918 (e.g., model). The corpus lookup identifier 918 may be as described in more detail in preceding sections in connection with the PII corpus lookup identifier or model configured to locate, for example, common personal names. The corpus lookup identifier 918 may generate eighth stream(s) of non-PII data (e.g., via sufficiency filter, as discussed elsewhere herein), stream(s) of PII data, and/or stream(s) of candidate PII data. As discussed in more detail above, the corpus lookup identifier 918 may be configured specifically for identification of PII within transaction records having the identified transaction channel(s) for the corresponding input PII candidate data stream(s) (e.g., respectively, transfer or non-transfer). Moreover, the sufficiency filter(s) of or which analyze output of the corpus lookup identifier 918 may be configured to treat all data not identified as PII as non-PII, and to include the non-PII in a non-PII output stream.

All PII identified at any point in the flow 900 of FIG. 9 (i.e., included within any PII output data stream) may be submitted to and/or redacted by one or more PII extractor/anonymizer(s) 920. For example, in one or more embodiments, redaction includes deleting the PII, replacing the PII characters and/or strings with nonce symbols or other meaningless or encrypted characters, or the like.

The non-PII (i.e., data included in any output non-PII data stream(s)) may be submitted to the anonymized data operation 922, which may output one or more redacted or anonymized transaction records. In one or more embodiments, the transaction record(s) may be reassembled by placing non-PII and redacted text (i.e., deleted spaces or non-characters) back in original positions within each transaction record. In one or more embodiments, reconstruction is unnecessary except to the extent of redacting the characters comprising PII. The resulting redacted or anonymized transaction records may be outputted or transmitted to a third party requester via an open banking platform.

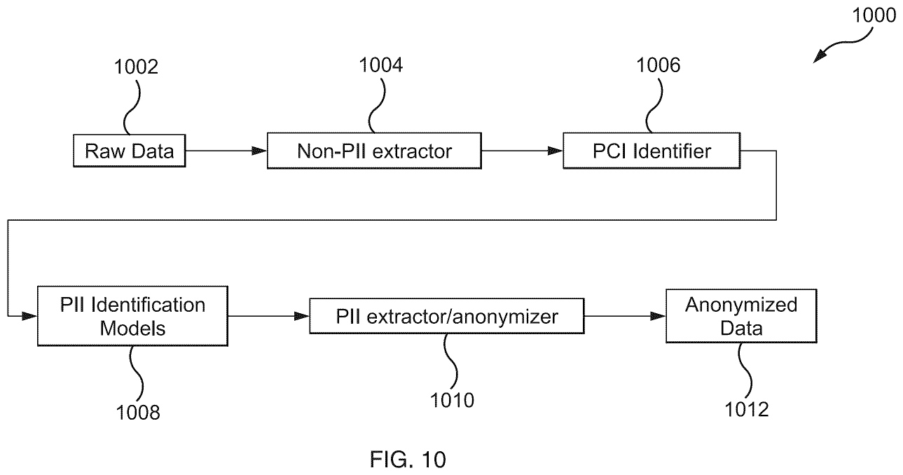

FIG. 10 depicts an example flow 1000 comprising a sub combination of the components proposed above, configured for computationally efficient redaction with reduced false positive rates based on transaction channel(s). More particularly, the flow 1000 proceeds, preferably sequentially, as described here.

Initially raw data 1002 such as open banking transaction records are submitted to one or more non-PII extractors 1004 (i.e., filter(s)). The non-PII extractors 1004 may be one or more of the filters described in more detail in the preceding sections of this disclosure. The filter(s) may individually or in group(s) generate first stream(s) of non-PII data and/or of candidate PII data.

The first candidate PII data output stream(s) from the one or more filter(s) may be input to a PCI identifier 1006. The PCI channel identifier 1006 may correspond to the PII channel identification regex model discussed above. The PCI channel identifier 1006 may output one or more second candidate PII data streams based on the transaction channel identification processes of the identifier. For example, second output streams of the PCI channel identifier 1006 may include a stream of data and/or transaction records determined to have originated with transfer transaction channel(s) and a stream of data and/or transaction records determined to have originated with non-transfer transaction channel(s).

One or more of the second candidate PII output stream(s) of the PCI identifier 1006 are submitted to one or more PII identifiers 1008, which may be selected from among the PII identifiers described in more detail in the preceding sections of this disclosure. Each of the PII identifiers 1008 may generate a stream of non-PII data (e.g., via sufficiency filter, as discussed elsewhere herein), a stream of PII data, and/or a stream of candidate PII data.

All or sub combinations of the one or more PII identifiers 1008 may be arranged in series or parallel relative to one another. Combinations of PII identifiers 1008 in series may be configured to identify PII specifically within transaction records having the same identified transaction channel(s) (e.g., transfer, non-transfer, or payment app, etc.). PII identifiers 1008 in parallel may respectively be configured to identify PII specifically within transaction records having different identified transaction channels. Combinations of PII identifiers 1008 in series may receive candidate PII data stream(s) from each preceding identifier in the series and output a candidate PII data stream to the next identifier in the series (along with its own PII output stream). Moreover, the sufficiency filter(s) of or which analyzes output of the last PII identifier to analyze a particular transaction type or PII channel (e.g., the last in a series configured for that PII channel) may be configured to treat all data not identified as PII as non-PII, and to include the non-PII in a non-PII output stream.

It should be appreciated from the discussion above that PII candidate stream(s) of a given PII channel or transaction type are routed to PII identifier(s) 1008 configured specifically for text analysis of records having that channel or transaction type. In one or more embodiments, the service device is configured to select the appropriate corresponding PII identifier(s) 1008 for each record or PII candidate stream from among a plurality of variously configured PII identifier(s) 1008. However, such routing operations may vary within the scope of the present invention.

All PII identified at any point in the flow 1000 of FIG. 10 (i.e., included within any PII output data stream) may be submitted to and/or redacted by one or more PII extractor/anonymizer(s) 1010. For example, in one or more embodiments, redaction includes deleting the PII, replacing the PII characters and/or strings with nonce symbols or other meaningless or encrypted characters, or the like.

The non-PII (i.e., data included in any output non-PII data stream(s)) may be submitted to the anonymized data operation 1012, which may output one or more redacted or anonymized transaction records. In one or more embodiments, the transaction record(s) may be reassembled by placing non-PII and redacted text (i.e., deleted spaces or non-characters) back in original positions within each transaction record. In one or more embodiments, reconstruction is unnecessary except to the extent of redacting the characters comprising PII. The resulting redacted or anonymized transaction records may be outputted or transmitted to a third party requester via an open banking platform.

One or ordinary skill will appreciate that other and/or less definite pipelines and flows are also within the scope of the present invention. More or fewer filter(s) and/or identifier(s) may be implemented.

For example, in one or more embodiments, one or more filters and, preferably, the SDK filter discussed above utilizing a corpus of known non-PII patterns representing and identifying duplicate text in key columns, may be applied to raw data or transaction records to produce a non-PII data stream and a candidate PII data stream. The candidate PII data stream is submitted to one or more PII identifiers to identify PII. Information not identified as PII or non-PII by the time it reaches the last of the PII identifiers may be considered non-PII, and redacted transaction records may be generated and/or transmitted according to the discussion of examples provided above.

For another example, in one or more embodiments, one or more filters (e.g., any of the filters discussed in more detail above), may be applied to raw data or transaction records to produce a non-PII data stream and a candidate PII data stream. The candidate PII data stream is submitted to the first and second regex models in series and as discussed in more detail above, respectively utilizing single and multiple (e.g., head/tail) patterns to generate one or more PII data stream(s). Information not identified as PII or non-PII by the time it is output from the second regex model may be considered non-PII, and redacted transaction records may be generated and/or transmitted according to the discussion of examples provided above.

For yet another example, in one or more embodiments, one or more filters (e.g., any of the filters discussed in more detail above), may be applied to raw data or transaction records to produce a non-PII data stream and a candidate PII data stream. The candidate PII data stream is submitted to the first and second NER models (respectively, filter and identifier, in a stacked configuration) to generate one or more non-PII data stream(s) (i.e., non-PII business names) and one or more PII data stream(s) (i.e., PII personal names and locations). Information not identified as PII or non-PII by the time it is output from the second (stacked) NER model may be considered non-PII, information identified as non-PII by the first NER filter but as PII by the second NER filter may be considered non-PII, and redacted transaction records may be generated and/or transmitted according to the discussion of examples provided above.

It should also be appreciated that data streams and extraction thereof from further analysis (i.e., pulling PII and non-PII out of the analysis pipeline whenever identified) are concepts described herein for ease of reference and visualization. All or portions of such extracted data and information may remain in each such flow throughout the entirety for optional reference by downstream components. In such cases, each component may simply annotate or flag PII and non-PII as identification thereof is made. Accordingly, for example, wherever a stacked NER is implemented, the second NER identifier or model may recognize conflicting identification with the first NER filter (i.e., where the same or overlapping text is variously and respectively categorized as both a PII personal name and a non-PII business name) by having the benefit of the continued access to the first NER filter's non-PII output stream (albeit in annotated, tagged or flagged form). However, in one or more embodiments, such downstream components may alternatively cross-reference output streams of such upstream components to perform such tie-breaking or weighted categorization operations within the scope of the present invention.

Example Computer-Implemented Method for Redaction of Open Banking Data

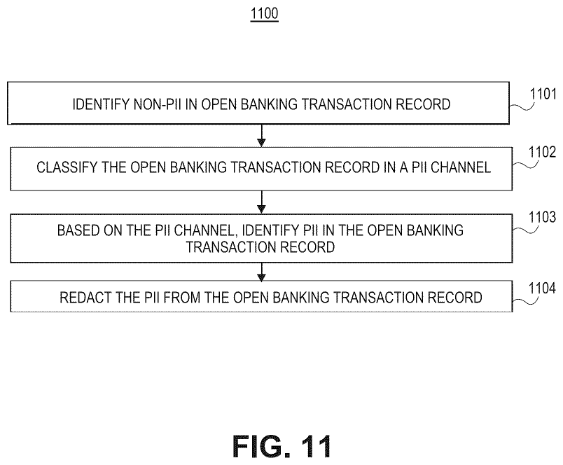

FIG. 11 depicts a flowchart including a listing of operations of an example computer-implemented method 1100 for redaction of open banking data. The operations may be performed in the order shown in FIG. 11, or they may be performed in a different order. Furthermore, some operations may be performed concurrently as opposed to sequentially. In addition, some operations may be optional.

The computer-implemented method 1100 is described below, for ease of reference, as being executed by example devices and components introduced with the embodiments illustrated in FIGS. 1-10. For example, the operations of the computer-implemented method 1100 may be performed by the service device 16 and the network 20 through the utilization of processors, transceivers, hardware, software, firmware, or combinations thereof, including in accordance with the flow illustrated in FIG. 10. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the operations outlined herein. The program(s) stored on the computer-readable medium(s) may instruct the processing element(s) to perform additional, fewer, or alternative actions, including those discussed elsewhere herein.

Referring to operation 1101, non-PII may be identified in an open banking transaction record. In one or more embodiments, the non-PII is identified by one or more filter(s) discussed in more detail in preceding portions of this disclosure. The non-PII may be identified on a service device of an open banking service and/or platform, or in a remote (e.g., cloud computing) environment.

For example, the raw open banking transaction record may be input to the one or more filter(s) or non-PII extractors, which may individually or in group(s) generate stream(s) of non-PII data and/or of candidate PII data, again in accordance with the discussion of preceding portions of this disclosure.

It should also be appreciated that a plurality of additional raw open banking transaction records may be treated with the open banking transaction record (e.g., in a data stream described in previous sections), and in the same manner as the open banking transaction record, throughout the method 1100.

Referring to operation 1102, a PII channel may be identified for the open banking transaction record. In one or more embodiments, the PII channel is a transaction type or channel identified by the PCI identifier discussed in more detail in preceding portions of this disclosure. The PII channel may be identified on a service device of an open banking service and/or platform, or in a remote (e.g., cloud computing) environment.

For example, the candidate PII data stream output by the filter(s)—that is, the open banking transaction record and any additional open banking transaction records in the data stream or portions thereof which have not been identified as non-PII by the filter(s)—may respectively be identified with a PII channel of transfer, non-transfer, payment app or the like for each transaction record represented therein, again in accordance with the discussion of preceding portions of this disclosure.

Referring to operation 1103, PII may be identified in the transaction record based on the identified PII channel. In one or more embodiments, the PII is identified by one or more PII identifiers discussed in more detail in preceding portions of this disclosure. The PII may be identified on a service device of an open banking service and/or platform, or in a remote (e.g., cloud computing) environment.

For example, the candidate PII data stream(s) output by the filter(s), now having a corresponding PII channel assigned to each transaction record represented therein, may be submitted to one or more PII identifier(s).

Each of the PII identifiers may generate a stream of non-PII data (e.g., via sufficiency filter, as discussed elsewhere herein), a stream of PII data, and/or a stream of candidate PII data.

All or sub combinations of the one or more PII identifiers may be arranged in series or parallel relative to one another. Combinations of PII identifiers in series may be configured to identify PII specifically within transaction records having the same identified transaction channel(s) (e.g., transfer, non-transfer, or payment app, etc.). PII identifiers in parallel may respectively be configured to identify PII specifically within transaction records having different identified transaction channels. Combinations of PII identifiers in series downstream of an initial one may receive candidate PII data stream(s) from each preceding identifier in the series, and, except for a last in the series, output a candidate PII data stream to the next identifier in the series (along with its own PII output stream). Moreover, sufficiency filter(s) of or which analyzes output of the last PII identifier to analyze a particular transaction type or PII channel (e.g., the last in a series configured for that PII channel) may be configured to treat all data not identified as PII as non-PII, and to include the non-PII in a non-PII output stream.

Referring to operation 1104, PII may be redacted from the transaction record. In one or more embodiments, the PII may be identified on a service device of an open banking service and/or platform, or in a remote (e.g., cloud computing) environment.

For example, all PII identified at any point in the flow of FIG. 11 (i.e., included within any PII output data stream of a PII identifier) may be submitted to and/or redacted by one or more PII extractor(s)/anonymizer(s). For example, in one or more embodiments, redaction includes deleting the PII, replacing the PII characters and/or strings with nonce symbols or other meaningless or encrypted characters, or the like.

The method may include additional, less, or alternate operation(s) and/or device(s), including those discussed elsewhere herein, unless otherwise expressly stated and/or readily apparent to those skilled in the art from the description.

For example, non-PII (i.e., data included in any output non-PII data stream(s)) may be submitted to an anonymized data operation, which may output one or more redacted or anonymized transaction records. In one or more embodiments, the transaction record(s) may be reassembled by placing non-PII and redacted text (i.e., deleted spaces or non-characters) back in original positions within each transaction record. In one or more embodiments, reconstruction is unnecessary except to the extent of redacting the characters comprising PII. The resulting redacted or anonymized transaction records may be outputted or transmitted to a third party requester via an open banking platform.

### Additional Considerations

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

We claim:

1. Non-transitory computer readable media having instructions stored thereon for redacting personally identifiable information that, when executed by at least one processor, cause the at least one processor to perform operations comprising:
identifying information that is not personally identifiable (non-PII) in an open banking transaction record;
classifying the open banking transaction record as belonging to one or more personally identifiable information channels (PII channels);
based on the PII channel identification, identifying personally identifiable information (PII) in the open banking transaction record, the PII identification including text analysis of the open banking transaction record performed using a first algorithm for the non-PII and a second algorithm for other data of the open banking transaction record; and
redacting the identified PII of the open banking transaction record.

2. The computer readable media of claim 1, wherein the first algorithm comprises logic which excludes the non-PII from comparison against known PII patterns, and the second algorithm matches the other data of the open banking transaction record against the known PII patterns.

3. The computer readable media of claim 2, wherein the first algorithm tags the non-PII for exclusion from the comparison operations of the second algorithm.

4. The computer readable media of claim of claim 1, wherein the redaction of the identified PII includes generating a redacted open banking transaction record, and wherein the instructions, when executed by the at least one processor, cause the at least one processor to output the redacted open banking transaction record to a third party requester via an open banking platform.

5. The computer readable media of claim 1, wherein the PII identification based on the PII channel identification includes selecting, based on the PII channel identification, a PII identification model from a plurality of PII identification models, the plurality of PII identification models being respectively configured for analyzing text from different ones of a plurality of corresponding PII channels, the selected PII identification model being configured for text analysis and PII identification within the identified PII channel.

6. The computer readable media of claim 5, the plurality of PII channels being defined at least in part according to corresponding transaction types, the transaction types including: (a) transfers, and (b) payment application (app) transactions.

7. The computer readable media of claim 1,
the one or more PII identification models including a first regular expression (regex) model and a second regex model,
the first regex model being configured to identify PII using a single pattern,
the second regex model being configured to identify PII using a plurality of patterns.

8. The computer readable media of claim 7, wherein when executed by the at least one processor the computer-executable instructions cause the at least one processor to perform operations comprising:
performing the non-PII identification, PII channel identification, PII identification, and redaction operations respectively for a plurality of additional open banking transaction records,
generating new regex patterns for identifying PII based on the redaction of the open banking transaction record and of the plurality of additional open banking transaction records,
updating the second regex model to include the new regex patterns.

9. The computer readable media of claim 1, wherein the PII identification by the second algorithm includes implementing a first named entity recognition (NER) model to identify PII associated with business entities and a second NER model to identify PII associated with individuals.

10. The computer readable media of claim 1, wherein the non-PII identification includes determining that a string of the data of the open banking transaction record matches a known non-PII pattern, the known non-PII pattern being generated based on duplicate instances in multiple transaction records associated with a plurality of different accountholders.

11. A computer-implemented method for redacting personally identifiable information comprising performing the following operations via one or more processors and/or one or more transceivers:
identifying information that is not personally identifiable (non-PII) in an open banking transaction record;
classifying the open banking transaction record as belonging to one or more personally identifiable information channels (PII channels);
based on the PII channel identification, identifying personally identifiable information (PII) in the open banking transaction record, the PII identification including text analysis of the open banking transaction record performed using a first algorithm for the non-PII and a second algorithm for other data of the open banking transaction record; and
redacting the identified PII of the open banking transaction record.

12. The computer-implemented method of claim 11, wherein the first algorithm comprises logic which excludes the non-PII from comparison against known PII patterns, and the second algorithm matches the other data of the open banking transaction record against the known PII patterns.

13. The computer-implemented method of claim 12, wherein the first algorithm tags the non-PII for exclusion from the comparison operations of the second algorithm.

14. The computer-implemented method of claim of claim 11, wherein the redaction of the identified PII includes generating a redacted open banking transaction record, and wherein the instructions, when executed by the at least one processor, further cause the at least one processor to output the redacted open banking transaction record to a third party requester via an open banking platform.

15. The computer-implemented method of claim 11, wherein the PII identification based on the PII channel identification includes selecting, based on the PII channel identification, a PII identification model from a plurality of PII identification models, the plurality of PII identification models being respectively configured for analyzing text from different ones of a plurality of corresponding PII channels, the selected PII identification model being configured for text analysis and PII identification within the identified PII channel.

16. The computer-implemented method of claim 15, the plurality of PII channels being defined at least in part according to corresponding transaction types, the transaction types including transfers and payment application (app) transactions.

17. The computer-implemented method of claim 11,
the one or more PII identification models including a first regular expression (regex) model and a second regex model,
the first regex model being configured to identify PII using a single pattern,
the second regex model being configured to identify PII using a plurality of patterns.

18. The computer-implemented method of claim 17, further comprising, via the one or more processors and/or one or more transceivers—
performing the non-PII identification, PII channel identification, PII identification, and redaction operations respectively for a plurality of additional open banking transaction records,
generating new regex patterns for identifying PII based on the open banking transaction record and the plurality of additional open banking transaction records,
updating the second regex model to include the new regex patterns.

19. The computer-implemented method of claim 11, wherein the PII identification by the second algorithm includes implementing a first named entity recognition (NER) model to identify PII associated with business entities and a second NER model to identify PII associated with individuals.

20. The computer-implemented method of claim 11, wherein the non-PII identification includes determining that a string of the data of the open banking transaction record matches a known non-PII pattern, the known non-PII pattern being generated based on duplicate instances in multiple transaction records associated with a plurality of different accountholders.
